(19) United States
(12) Patent Application Publication
(10) Pub. No.: US 2014/0153796 A1
(43) Pub. Date: Jun. 5, 2014

(54) MEDICAL IMAGING SYSTEM AND METHOD FOR ACQUIRING IMAGE USING A REMOTELY ACCESSIBLE MEDICAL IMAGING DEVICE INFRASTRUCTURE

(71) Applicant: General Electric Company, Schenectady, NY (US)

(72) Inventors: Subin Sarojam Baby Sundaran, Bangalore (IN); Shesha Prakash Kalasapura, Bangalore (IN)

(21) Appl. No.: 14/092,359

(22) Filed: Nov. 27, 2013

(30) Foreign Application Priority Data
Nov. 30, 2012 (IN) 5017/CHE/2012

(51) Int. Cl. G06T 7/00

(52) U.S. Cl. CPC G06T 7/00
USPC 382/128

(57) ABSTRACT

A medical imaging system capable of acquiring image using a remotely accessible medical imaging device infrastructure. The medical imaging system includes an imaging client communicably coupled to an image acquisition unit. The imaging client is configured to transmit image data of an object acquired using the image acquisition unit, wherein the image data is acquired based on an imaging procedure. Imaging servers hosting medical imaging device infrastructures are communicably coupled to the imaging client. The imaging servers are configured to allocate a medical imaging device from the medical imaging device infrastructures to the imaging client based on the imaging procedure; process the image data received from the imaging client in the medical imaging device to generate images; and send the images to the imaging client. The imaging client is further configured to render the images of the object.

### TECHNICAL FIELD

The subject matter disclosed herein relates to a medical imaging system. More specifically the subject matter relates to a method of acquiring image using a remotely accessible medical imaging device infrastructure.

### BACKGROUND OF THE INVENTION

Medical imaging systems are used in different applications to image different regions or areas (e.g. different organs) of patients or other objects. The medical imaging systems to be used vary depending on an imaging procedure to be performed. For instance conventionally different medical imaging systems may be required for performing a cardiac imaging, an obstetric imaging, a computed tomography imaging, and an ultrasound imaging. If a user needs to perform a particular type of imaging procedure then a medical imaging device that can perform the particular imaging procedure needs to be obtained. Further these imaging devices are located close to the patient undergoing the imaging procedure. In the case of a conventional ultrasound imaging device, an ultrasound probe need to be placed on the object to acquire the probe image data and processing of image data associated with the object is performed in the ultrasound imaging device. The ultrasound imaging device and the object may be physically present in the same location. The results of processed image data is displayed in a user interface of the ultrasound imaging device for a technician's review. Handling of these medical imaging devices also remains cumbersome due to the need of multiple imaging devices for performing different operations.

Due to these reasons an improved medical imaging system for acquiring images of an object is desired.

### BRIEF DESCRIPTION OF THE INVENTION

The above-mentioned shortcomings, disadvantages and problems are addressed herein which will be understood by reading and understanding the following specification.

As discussed in detail below, embodiments of the invention include a medical imaging system capable of acquiring image using a remotely accessible medical imaging device infrastructure is disclosed. The medical imaging system includes an imaging client communicably coupled to an image acquisition unit. The imaging client is configured to transmit image data of an object acquired using the image acquisition unit, wherein the image data is acquired based on an imaging procedure. One or more imaging servers hosting one or more medical imaging device infrastructure are communicably coupled to the imaging client. The one or more imaging servers are configured to allocate a medical imaging device from the one or more medical imaging device infrastructure to the imaging client based on the imaging procedure; process the image data received from the imaging client in the medical imaging device to generate one or more images; and send the one or more images to the imaging client. The imaging client is further configured to render the one or more images of the object.

In another embodiment a method of acquiring an image of an object using a remotely accessible medical imaging device infrastructure is disclosed. The method involves transmitting image data of an object acquired using an image acquisition unit to an imaging client for display after post processing, wherein the image data is acquired based on an imaging procedure; allocating a medical imaging device from one or more medical imaging device infrastructure to the imaging client based on the imaging procedure; processing the image data received from the imaging client in the medical imaging device to generate one or more images; sending the one or more images to the imaging client; and rendering the one or more images of the object by the imaging client.

### BRIEF DESCRIPTION OF THE DRAWINGS

FIG. 1 illustrates an ultrasound imaging system that directs ultrasound energy pulses into an object, typically a human body, and creates an image of the body based upon the ultrasound energy reflected from the tissue and structures of the body;

FIG. 2 a schematic representation of a medical imaging system for performing imaging of an object in accordance with an embodiment;

FIG. 3 is a schematic representation of a user device communicating with an imaging server for performing imaging of the object in accordance with an embodiment;

FIG. 4 illustrates a schematic illustration of multiple user devices communicating with a virtualization unit in accordance with an embodiment;

FIG. 5 is a schematic illustration of medical imaging device infrastructures arranged in a cloud based environment in accordance with an embodiment; and

FIG. 6 illustrates a block diagram of a method acquiring an image of an object using a remotely accessible medical imaging device infrastructure in accordance with an embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

To the extent that the figures illustrate diagrams of the functional blocks of various embodiments, the functional blocks are not necessarily indicative of the division between hardware circuitry. One or more of the functional blocks (e.g., processors or memories) may be implemented in a single piece of hardware (e.g., a general purpose signal processor or random access memory, hard disk, or the like) or multiple pieces of hardware. Similarly, the programs may be standalone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

A medical imaging system capable of acquiring image using a remotely accessible medical imaging device infrastructure is disclosed. The medical imaging system includes an imaging client communicably coupled to an image acquisition unit. The imaging client is configured to transmit image data of an object acquired using the image acquisition unit, wherein the image data is acquired based on an imaging procedure. One or more imaging servers hosting one or more medical imaging device infrastructure are communicably coupled to the imaging client. The one or more imaging servers are configured to allocate a medical imaging device from the one or more medical imaging device infrastructure to the imaging client based on the imaging procedure; process the image data received from the imaging client in the medical imaging device to generate one or more images; and send the one or more images to the imaging client. The imaging client is further configured to render the one or more images of the object. Although the various embodiments are described with respect to an ultrasound imaging system, the various embodiments may be utilized with any suitable medical imaging system, for example, X-ray, computed tomography, single photon emission computed tomography, magnetic resonance imaging, or the like.

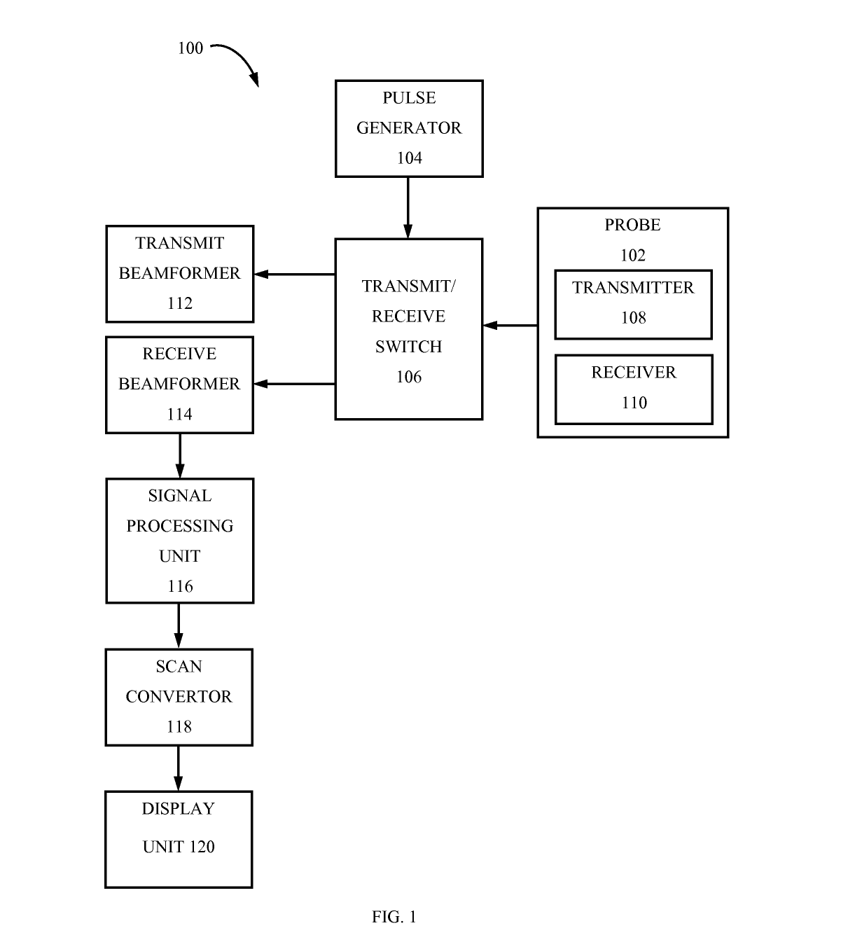

FIG. 1 shows an ultrasound imaging system 100 that directs ultrasound energy pulses into an object, typically a human body, and creates an image of the body based upon the ultrasound energy reflected from the tissue and structures of the body. The ultrasound imaging system 100 comprises a probe 102 (i.e. an image acquisition unit) that includes a transducer array having a plurality of transducer elements. The probe 102 and the ultrasound imaging system 100 may be physically connected, such as through a cable, or they may be in communication through a wireless technique. The transducer array can be one-dimensional (1-D) or two-dimensional (2-D). A 1-D transducer array comprises a plurality of transducer elements arranged in a single dimension and a 2-D transducer array comprises a plurality of transducer elements arranged across two dimensions namely azimuthal and elevation. The number of transducer elements and the dimensions of transducer elements may be the same in the azimuthal and elevation directions or different. Further, each transducer element can be configured to function as a transmitter 108 or a receiver 110. Alternatively, each transducer element can be configured to act both as a transmitter 108 and a receiver 110. The ultrasound imaging system 100 further comprises a pulse generator 104 and a transmit/receive switch 106. The pulse generator 104 is configured for generating and supplying excitation signals to the transmitter 108 and the receiver 110. The transmitter 108 is configured for transmitting ultrasound beams, along a plurality of transmit scan lines, in response to the excitation signals. The term “transmit scan lines” refers to spatial directions on which transmit beams are positioned at some time during an imaging operation. The receiver 110 is configured for receiving echoes of the transmitted ultrasound beams. The transmit/receive switch 106 is configured for switching transmitting and receiving operations of the probe 102.

The ultrasound imaging system 100 further comprises a transmit beamformer 112 and a receive beamformer 114. The transmit beamformer 112 is coupled through the transmit/receive (T/R) switch 106 to the probe 102. The transmit beamformer 112 receives pulse sequences from the pulse generator 104. The probe 102, energized by the transmit beamformer 112, transmits ultrasound energy into a region of interest (ROI) in a patient's body. As is known in the art, by appropriately delaying the waveforms applied to the transmitter 108 by the transmit beamformer 112, a focused ultrasound beam may be transmitted. The probe 102 is also coupled, through the T/R switch 106, to the receive beamformer 114. The receiver 110 receives ultrasound energy from a given point within the patient's body at different times. The receiver 110 converts the received ultrasound energy to transducer signals which may be amplified, individually delayed and then accumulated by the receive beamformer 114 to provide a receive signal that represents the received ultrasound levels along a desired receive line (“transmit scan line” or “beam”). The receive signals are image data that can be processed to obtain images i.e. ultrasound images of the region of interest in the patient's body. The receive beamformer 114 may be a digital beamformer including an analog-to-digital converter for converting the transducer signals to digital values. As known in the art, the delays applied to the transducer signals may be varied during reception of ultrasound energy to effect dynamic focusing. The process of transmission and reception is repeated for multiple transmit scan lines to create an image frame for generating an image of the region of interest in the patient's body.

In an alternative system configuration, different transducer elements are employed for transmitting and receiving. In that configuration, the T/R switch 106 is not included, and the transmit beamformer 112 and the receive beamformer 114 are connected directly to the respective transmit or receive transducer elements. The receive signals from the receive beamformer 114 are applied to a signal processing unit 116, which processes the receive signals for enhancing the image quality and may include routines such as detection, filtering, persistence and harmonic processing. The output of the signal processing unit 116 is supplied to a scan converter 118. The scan converter 118 creates a data slice from a single scan plane. The data slice is stored in a slice memory and then is passed to a display unit 120, which processes the scan converted image data so as to display an image of the region of interest in the patient's body.

In one embodiment, high resolution is obtained at each image point by coherently combining the receive signals thereby synthesizing a large aperture focused at the point. Accordingly, the ultrasound imaging system 100 acquires and stores coherent samples of receive signals associated with each receive beam and performs interpolations (weighted summations, or otherwise), and/or extrapolations and/or other computations with respect to stored coherent samples associated with distinct receive beams to synthesize new coherent samples on synthetic scan lines that are spatially distinct from the receive scan lines and/or spatially distinct from the transmit scan lines and/or both. The synthesis or combination function may be a simple summation or a weighted summation operation, but other functions may as well be used. The synthesis function includes linear or nonlinear functions and functions with real or complex, spatially invariant or variant component beam weighting coefficients. The ultrasound imaging system 100 then in one embodiment detects both acquired and synthetic coherent samples, performs a scan conversion, and displays or records the resulting ultrasound image. Ultrasound data is typically acquired in image frames, each image frame representing a sweep of an ultrasound beam emanating from the face of the transducer array. A 1-D transducer array produces 2-D rectangular or pie-shaped sweeps, each sweep being represented by a series of data points. Each of the data points are, in effect, a value representing the intensity of an ultrasound reflection at a certain depth along a given transmit scan line. On the other hand, the 2-D transducer array allows beam steering in two dimensions as well as focus in the depth direction. This eliminates the need to physically move the probe 102 to translate focus for the capture of a volume of ultrasound data to be used to render 3-D images.

One method to generate real-time 3-D scan data sets is to perform multiple sweeps wherein each sweep is oriented in a different scan plane. The transmit scan lines of every sweep are typically arrayed across the probe's 102 “lateral” dimension. The planes of the successive sweeps in an image frame are rotated with respect to each other, e.g. displaced in the “elevation” direction, which is typically orthogonal to the lateral dimension. Alternatively, successive sweeps may be rotated about a centerline of the lateral dimension. In general, each scan frame comprises plurality of transmit scan lines allowing the interrogation of a 3-D scan data set representing a scan volume of some pre-determined shape, such as a cube, a sector, frustum, or cylinder.

In one exemplary embodiment, each scan frame represents a scan volume in the shape of a sector. Therefore the scan volume comprises multiple sectors. Each sector comprises plurality of beam positions, which may be divided into sub sectors. Each sub sector may comprise equal number of beam positions. However, it is not necessary for the sub sectors to comprise equal number of beam positions. Further, each sub sector comprises at least one set of beam positions and each beam position in a set of beam positions is numbered in sequence. Therefore, each sector comprises multiple sets of beam positions indexed sequentially on a predetermined rotation. Plurality of transmit beam sets are generated from each sector. Further, each transmit beam set comprises one or more simultaneous transmit beams depending on the capabilities of the ultrasound imaging system 100. The term “simultaneous transmit beams” refers to transmit beams that are part of the same transmit event and that are in flight in overlapping time periods. Simultaneous transmit beams do not have to begin precisely at the same instant or to terminate precisely at the same instant. Similarly, simultaneous receive beams are receive beams that are acquired from the same transmit event, whether or not they start or stop at precisely the same instant. The transmit beams in each transmit beam set are separated by the plurality of transmit scan lines wherein each transmit scan line is associated with a single beam position. Thus, the multiple transmit beams are arranged in space separated such that they do not have significant interference effects. The transmit beamformer 112 can be configured for generating each transmit beam set from beam positions having the same index value. Thus, beam positions with matching index value, in each sub sector, can be used for generating multiple simultaneous transmit beams that form a single transmit beam set. In one embodiment, at least two consecutive transmit beam sets are generated from beam positions not indexed sequentially. In an alternative embodiment, at least a first transmit beam set and a last transmit beam set, in a sector, are not generated from neighboring beam positions.

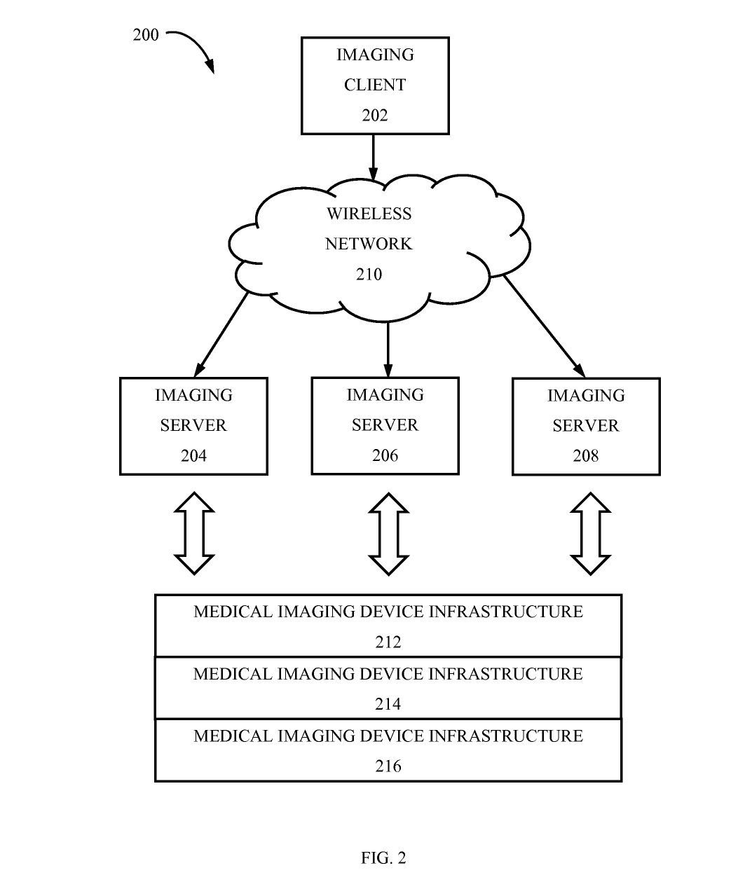

FIG. 2 is a schematic representation of a medical imaging system 200 for performing imaging of an object in accordance with an embodiment. The medical imaging system 200 includes an imaging client 202 configured to communicate with one or more imaging servers such as an imaging server 204, an imaging server 206 and an imaging server 208 over a wireless network 210. The imaging client 202 may operate in a user device of a user performing the imaging of the object. The user device may include a laptop, a portable medical imaging device, a desktop and a mobile device. The wireless network 210 may include but are not limited to, a Local Area Network (LAN), a wireless LAN (WLAN), a Wireless Wide Area Network (Wireless WAN), a Wireless Personal Area Network (Wireless PAN), a Wireless Metropolitan Area Network (Wireless MAN), a Wireless Telecommunication Network, a 3^{rd} Generation communication (3G) network, a 4^{th} Generation communication (4G) network, and a Long Term Evolution communication (4G LTE) network. The imaging client 202 is communicably coupled to an image acquisition unit (shown in FIG. 1) for acquiring image data from the object. For example the image acquisition unit may be an ultrasound probe connected to the user device having the imaging client 202. The probe and the user device may be physically connected, such as through a cable, or they may be in communication through a wireless technique.

During operation the imaging client 202 receives an imaging procedure to be performed as a user input. The image data associated with the object is acquired using the image acquisition unit based on the imaging procedure. The image data is transmitted over the wireless network 210 to the one or more imaging servers. An imaging server may be selected based on the imaging procedure and processes the image data. Each imaging server is configured to perform a set of imaging procedures based on its capabilities. The imaging procedures include for example, abdominal imaging, cardiac imaging, obstetric imaging, fetal imaging, and renal imaging. Each imaging procedure also have their respective imaging parameters such as frequency, speckle reduction imaging, imaging angle, time gain compensation, scan depth, gain, scan format, image frame rate, field of view, focal point, scan lines per image frame, number of imaging beams and pitch of the imaging elements (for e.g. transducer elements). The imaging client 202 may be configured to present different imaging procedures that can be performed through a user interface. The user interface may be a web-based user interface. The user interface also presents imaging parameters associated with an imaging procedure when selected by the user. The user then modifies these imaging parameters based on their requirement for performing the imaging procedure.

An imaging server that is capable of processing the user input receives this parameter change input. The one or more imaging servers host one or more medical imaging device infrastructures. For instance the imaging server 204, the imaging server 206 and the imaging server 208 host a medical imaging device infrastructure 212, a medical imaging device infrastructure 214, and a medical imaging device infrastructure 216. In an embodiment a medical imaging device infrastructure includes one or more medical imaging devices such as, an ultrasound imaging device, a magnetic resonance imaging device, X-ray device, and a computed tomography device. In another scenario a medical imaging device infrastructure includes multiple ultrasound imaging devices. However in other embodiments, the medical imaging device infrastructures may have hardware components and software functions of any one or more medical imaging devices such as specific medical imaging devices and low powered medical imaging devices. It may be envisioned that a medical imaging device infrastructure may have different types of hardware and software capabilities similar to any medical imaging device in any other combination. The one or more medical imaging device infrastructures may be located in a remote location or different remote locations.

The imaging server allocates a medical imaging device from the one or more medical imaging device infrastructures to the imaging client 202 based on the imaging procedure received from the user. Explaining by way of an example the imaging server 204 receives the user input including an abdominal imaging procedure and associated imaging parameters and allocates a medical imaging device from the medical imaging device infrastructure 212 to process the user input. The medical imaging device may be an ultrasound imaging device capable of performing the abdominal imaging. Thus the user can connect or use an ultrasound imaging device for a particular application i.e., abdominal imaging. The image data is acquired from the object i.e. human's body based on the imaging procedure by the imaging acquisition unit. The image data is transmitted to the imaging server which is processed to generate one or more images. The one or more images are then transmitted to the imaging client where these images are rendered to present the images to the user. The one or more images are transmitted in the form of multiple image frames. Considering the example described hereinabove, the images of the abdomen are generated and transmitted to the imaging client for rendering. The one or more images generated may be stored in the imaging server. The imaging server may be connected to a storage device configured to store the one or more images. The storage device may be located in a remote location. Now referring back to the imaging client 202, the user may also submit request various other activities other than performing imaging procedures on the object. These activities may include registration of an object (i.e. a patient), generation and printing of health reports, and maintaining worksheet. The activities may be processed in the imaging server (204, 206, 208) located in the remote location and processed data may be presented by the imaging client 202. In various embodiments the imaging client 202 provides appropriate user interfaces to the user for communicating with the imaging server for performing these activities described above. Further the imaging client 202 also enables the user to select a medical imaging device of user's requirement through the user interface provided by the imaging client 202. The user interface provides options for selecting an imaging procedure and corresponding imaging parameters of user's choice and accordingly an appropriate medical imaging device is allocated to the user to perform the imaging procedure.

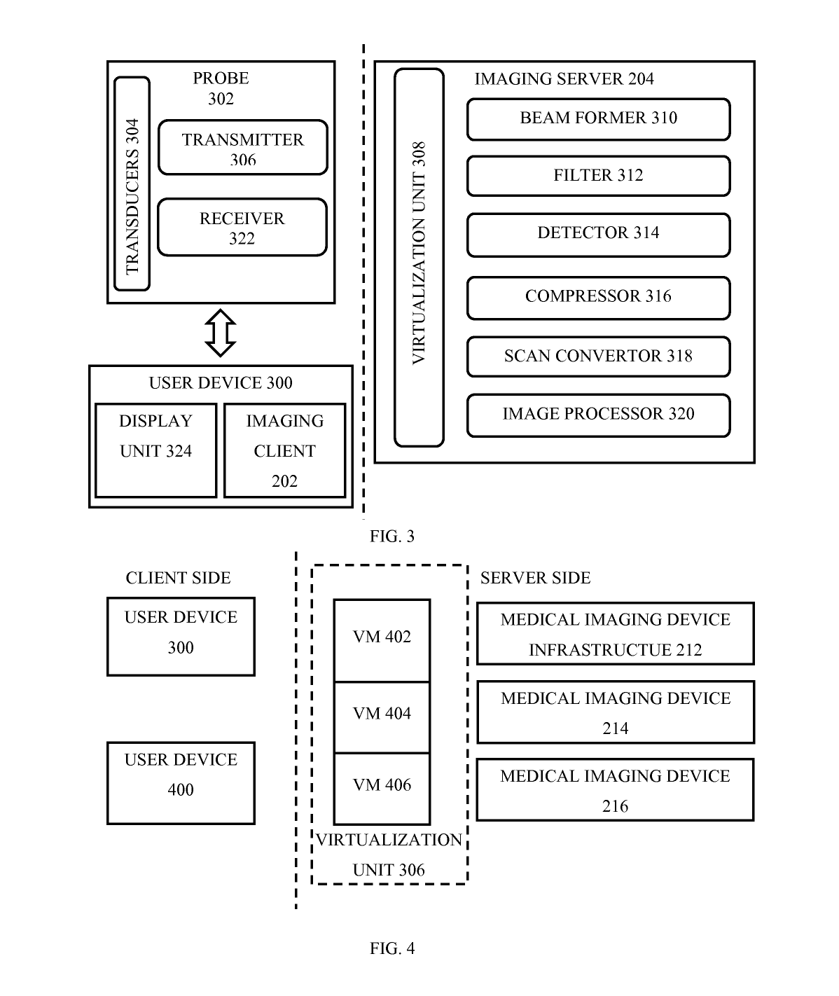

FIG. 3 is a schematic representation of a user device 300 communicating with an imaging server 204 for performing imaging of the object in accordance with an embodiment. The user device 300 as described in conjunction with FIG. 2 includes for example a laptop, a portable medical imaging device, a desktop and a mobile device. The user device 300 communicates with a probe 302 (i.e. an image acquisition unit) including transducers 304. The transducers 304 are activated to acquire the image data. The image data acquired are transmitted through a transmitter 306 to the imaging server 204. The transmitter 306 also sends a request including information associated with the imaging procedure selected by the user and one or more imaging parameters associated with the imaging procedure. The request is received at a virtualization unit 308 that is configured as a virtualization layer for processing all the input requests received from the user device 300. The virtualization unit 308 includes multiple virtual machines that may be capable of processing input requests received from multiple user devices. The imaging server 204 acts as a host machine hosting the multiple virtual machines. The imaging server 204 also hosts multiple medical imaging device infrastructures as described above in conjunction with FIG. 2. The imaging server 204 in FIG. 3 is shown to include different hardware and software function modules such as a beam former 310, a filter 312, a detector 314, a compressor 316, a scan convertor 318 and an image processor 320. These modules may be associated with one or more medical imaging device infrastructures and presented in this manner in FIG. 2 for ease of representation. Further the imaging server 204 shown in FIG. 3 is described in the context of an ultrasound imaging procedure and accordingly the hardware and software function modules may be associated with the ultrasound imaging. However it may be envisioned that an imaging server may include other hardware and software modules pertaining to any other imaging procedure. Based on the selected imaging procedure the beam former 310 energizes the transducers 304 upon receiving pulse sequences. The transducers 304 transmit imaging energy (i.e. ultrasound energy) into a ROI in the object (i.e. human body). Ultrasound energy received from the ROI is received at the transducers 304 and then processed by a receiver 322 to generate the image data in the form of transducer signals. These transducer signals are then filtered using the filter 312. The filter 312 may include a band-pass filter and other filters for filtering the transducer signals from noises or other signals outside frequencies of interest. Filtered transducer signals i.e. filtered image data generated are then processed by the detector 314 using different transformation methodologies and filtering methods. The transformation methodologies such as Hilbert transform may be used to process the filtered transducer signals to generate an analytic representation of these signals. Further these filtered transducer signals may be then demodulated in baseband and filtered using a low pass filtering method.

The filtered transducer signals processed by the detector 314 are received at the compressor 316 and these signals are compressed to fit within a dynamic range used for displaying for example 7 or 8 bits. For instance a parameter that may be adjusted while performing compression is brightness and contrast. The compressed transducer signals are then received at the scan convertor 318 wherein raw compressed transducer signals are interpolated to display image data. The raw compressed transducer signals may in one of the coordinates system for example, a Cartesian coordinate system and a polar coordinate system. The scan convertor 318 performs coordinate transformation step to interpolate the raw compressed transducer signals accurately on a display unit 324 depending on display resolution of the display unit 324. Different interpolation techniques such as a bilinear interpolation, a linear interpolation, and 4×4 interpolation may be adopted by the scan convertor 318. The interpolated signals are then pre-processed by the image processor 320 to obtain one or more images. Further in various other embodiments the interpolated signals may be processed using different other filtering methodologies such as but not limited to angle (spatial) compounding, frame smoothing, boundary or edge detection, speckle reduction, multi-scale or wavelet decomposition with soft thresholding, anisotropic filtering, bilateral filtering, histogram equalization and doppler processing. FIG. 3 is shown to include few hardware and software function modules explained hereinabove however it may be envisioned that various other embodiment may include modules for performing different filtering methodologies discussed above.

The one or more images generated are sent to the imaging client 202 such communicating with the user device 300. The imaging client 202 receives the one or more images and processes these images to be displayed in the display unit 324. In an embodiment the imaging client 202 may be a web-based application. In this case a web browser may be displayed in the display unit 324 through which the one or more images may be presented. The imaging client 202 may include a user interface for presenting the one or more images. The user interface may be a web-based user interface. As the processing of the image data to obtain the one or more images of the object is performed in the imaging server 204, the imaging client 202 configured in the user device 300 may be a thin client application. The thin client may be installed in the user device 300 and may be time to time updated with various functional modifications. The functional modifications may also but not limited to include addition of more imaging procedures, and addition of medical imaging devices in the medical imaging device infrastructures. In an embodiment the imaging client 202 may be configured using a portable device connected to the user device 300. The portable device may be a USB device or a plug-n-play type dongle. Thus the user device 300 may be conveniently used by the user for acquiring the image data.

Turning now to FIG. 4 illustrating a schematic illustration of multiple user devices such as the user device 300 and a user device 400 communicating with the virtualization unit 306 in accordance with an embodiment. It may be noted that more user devices may simultaneously communicate with the virtualization unit 306 along with the user device 300 and the user device 400. To handle requests from the user device 300 and the user device 400 the virtualization unit 306 may be configured into multiple virtual machines (VMs) such as a VM 402, a VM 404 and a VM 406. The virtualization unit 306 as shown herein is divided into three VMs however the virtualization unit 306 may include more VMs. The user device 300 may send a request to the virtualization unit 306 for performing an imaging procedure. Any one VM of the virtualization unit 306 may handle this request. The VM may be selected based on the imaging procedure and the associated imaging parameters that need to be processed. In an embodiment the VM is also selected based on a current load on the VM. The term “load” is used in this disclosure to refer to number of requests being processed by a VM at a given instance of time with respect to its capacity of processing the requests. In this embodiment a load balancer may be communicably coupled to the virtualization unit 306. The load balancer may have information indicating load associated with all the VMs and based on this load information the request is allocated to an appropriate VM. In an exemplary embodiment the request may be partially processed by a VM and the remaining portion of the request may be processed by another VM.

Considering an example, the request is received by the VM 402 and then the imaging procedure selected by the user is analyzed and an appropriate medical imaging device infrastructure 304 is identified. The medical imaging device infrastructure 304 may include multiple medical imaging devices. Based on the imaging procedure the VM 402 may allocate one or more medical imaging devices from the medical imaging device infrastructure 304 to process the request. The one or more medical imaging devices are then prepared to start receiving the image data and further processing. The processing of the image data is described in detail in conjunction with FIG. 1 and FIG. 2 and hence will not be discussed in detail here. Subsequently the image data is acquired at the user device 300 and transmitted to the VM 402, and processed by the one or more medical imaging devices to obtain the one or more images. The one or more images are transmitted to the user device 300 by the VM 402. These images are then displayed to the user through the user device 300. The virtualization unit 306 also receives request from the user device 400 which is then allocated to an appropriate VM based on the load information. The selected VM then allocates or assigns the medical imaging device infrastructure 212 to process this request. The medical imaging device infrastructure 212 is selected based on a load associated with this infrastructure. The load herein refers to amount of processes (i.e. imaging procedures) handled by a medical imaging device infrastructure at a particular instance. Further the selected VM also checks for load associated with one or more medical imaging devices present in the medical imaging device infrastructure 212 for identifying appropriate medical imaging devices for processing the request. The medical imaging device infrastructures 212, 214 and 216 are located in a particular location and the virtualization unit 306 in the imaging server is used to process all the requests from different users present in different locations, and thus there is an ease in whole procedure of acquiring images of the object. The medical imaging device infrastructures may be arranged or located in one or more locations.

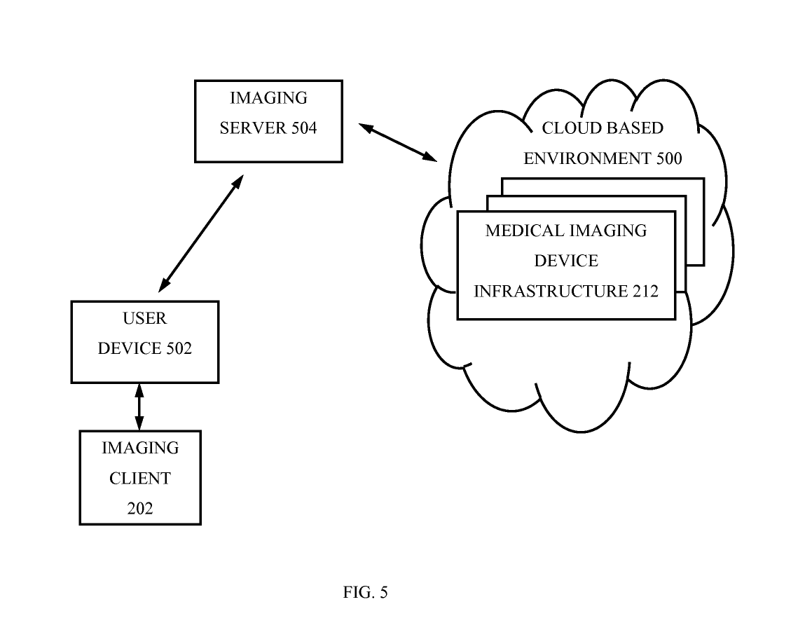

The medical imaging device infrastructures may be arranged in a cloud based environment 500 in accordance with an embodiment as illustrated in FIG. 5. As illustrated the cloud based environment 500 includes multiple medical imaging device infrastructures 212, and hardware and software capabilities or functionalities of these infrastructures 212 are provided as a service to a user device 502 through an imaging server 504. The cloud based environment 500 may be set up in a remote location. The cloud based environment 500 may be a private cloud, a public cloud, a hybrid cloud and a community cloud. The hardware and software capabilities or functionalities of these medical imaging device infrastructures 212 are provided over a network for example internet. Thus an end user of the user device 502 may use a user interface for accessing the medical imaging device infrastructures 212. The user interface may be for example a web browser application, a light weight desktop application, a mobile application or any other application that may operate in the user device 502. Image data acquired from the object may be transferred through the user interface to a medical imaging device infrastructure of the cloud based environment 500. In an embodiment the service provided by the cloud based environment 500 may function using a pay per user model. In the pay per use model the user of the user device 502 may be provided with a paid service for accessing or using the medical imaging device infrastructures 212 from the cloud based environment 500. The term “service” described herein in this disclosure refers to a process involving a user being provided with facility of performing different imaging procedures using the medical imaging device infrastructures 212 present in a cloud based environment. Depending on the usage or load of the medical imaging device infrastructures 212 for generating the images of the object the user may pay. The usage may be calculated based on but not limited to number of hours of service, kinds of service, and number of services used. In another embodiment the user may use this service based on a subscription model. In this model the user may subscribe for few medical imaging device infrastructures that are useful for the user. For instance the user may need to perform a set of imaging procedures such as cardiac imaging, abdominal imaging and obstetric imaging, and accordingly the user subscribes for one or more medical imaging device infrastructures that can perform the set of imaging procedures. The user pays for these services based on the usage. Even though only two models are being discussed in a cloud based environment 500 it may be envisioned that in various other embodiments different techniques may be used for providing these services to the user through the cloud based environment 500. The cloud environment 500 may be updated with more medical imaging devices when time passes and thus the user need to be aware of these new medical imaging devices in an existing medical imaging device infrastructure or a new medical imaging device infrastructure. In an embodiment the user device 502 may be configured to present the newly added imaging devices or the medical imaging device infrastructure to the user through the user interface. The user may then subscribe for a newly added medical imaging device or a newly added medical imaging device infrastructure based on user's requirement. Thus the user need not procure a medical imaging device or a medical imaging device infrastructure for performing any imaging procedures.

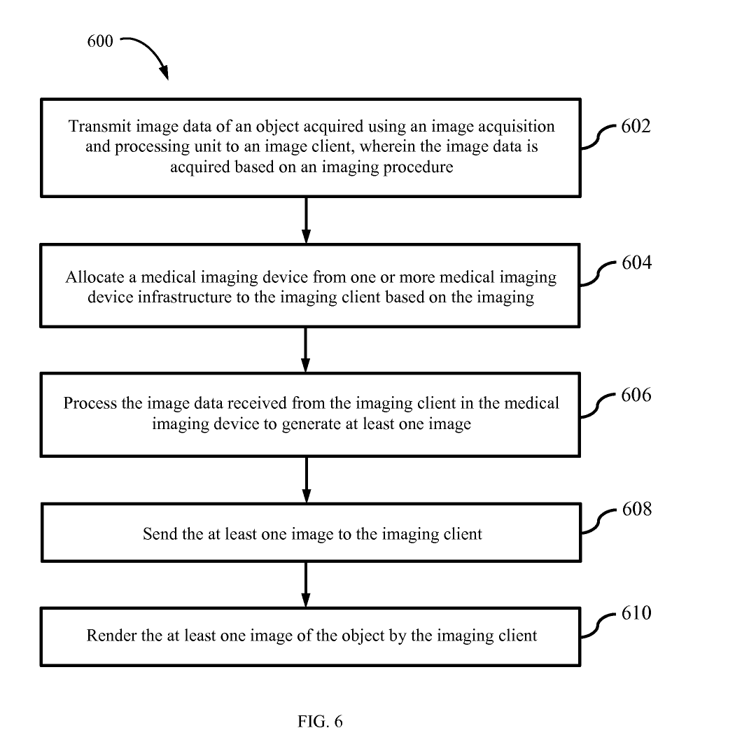

FIG. 6 illustrates a block diagram of a method 600 of acquiring an image of an object using a remotely accessible medical imaging device infrastructure in accordance with an embodiment. In an embodiment a medical imaging device infrastructure includes one or more medical imaging devices such as, an ultrasound imaging device, a magnetic resonance imaging device, X-ray device, and a computed tomography device. In another scenario a medical imaging device infrastructure includes multiple ultrasound imaging devices. However in other embodiments, the medical imaging device infrastructures may have hardware components and software functions of any one or more medical imaging devices. It may be envisioned that a medical imaging device infrastructure may have different types of hardware and software capabilities similar to any medical imaging device in any other combination. The one or more medical imaging device infrastructures may be located in a remote location or different remote locations. The user may have a user device communicably connected to an image acquisition unit for acquiring image data of the object. The image acquisition unit is communicably connected to the imaging client through the user device. The image data of the object is acquired based on the imaging procedure selected by the user. The acquired image data is transmitted to the imaging client at step 602. The imaging server allocates a medical imaging device from the one or more medical imaging device infrastructures to the imaging client based on the imaging procedure received from the user at step 604. For instance an imaging server receives user input or a request including an abdominal imaging procedure and associated imaging parameters. The imaging server then identifies and allocates a medical imaging device from the medical imaging device infrastructure to process the user input. The medical imaging device may be an ultrasound imaging device capable of performing the abdominal imaging. The image data is acquired from the object i.e. human's body based on the imaging procedure by the imaging acquisition unit. The medical imaging device is identified based on a load associated with this medical imaging device and a load associated with the medical imaging device infrastructure that includes the identified medical imaging device. The load herein refers to amount of processes (i.e. imaging procedures) handled by the medical imaging device infrastructure at a particular instance. Now at step 606, the image data acquired is processed in the identified medical imaging device to generate the one or more images. The processing method in the medical imaging device involves receiving the image data in the form of transducer signals. These transducer signals are filtered using one or more filters. The filters may include a band-pass filter and other filters for filtering the transducer signals from noises or other signals outside frequencies of interest. Filtered transducer signals i.e. filtered image data generated are then processed by a detector using different transformation methodologies and filtering methods. The transformation methodologies such as Hilbert transform may be used to process the filtered transducer signals to generate an analytic representation of these signals. Further these filtered transducer signals may be then demodulated in baseband and filtered using a low pass filtering method.

The filtered transducer signals processed by the detector are received at a compressor and these signals are compressed to fit within a dynamic range used for displaying for example 7 or 8 bits. For instance a parameter that may be adjusted while performing compression is brightness and contrast. The compressed transducer signals or compressed image data are then received at a scan convertor wherein raw compressed transducer signals are interpolated to display image data. The raw compressed transducer signals may in one of the coordinates system for example, a Cartesian coordinate system and a polar coordinate system. The scan convertor performs coordinate transformation step to interpolate the raw compressed transducer signals accurately on a display unit of the user device depending on display resolution of the display unit. Different interpolation techniques such as a bilinear interpolation, a linear interpolation, and 4×4 interpolation may be adopted by the scan convertor. The interpolated signals are then pre-processed by an image processor to obtain one or more images. Further in various other embodiments the interpolated signals may be processed using different other filtering methodologies such as but not limited to angle (spatial) compounding, frame smoothing, boundary or edge detection, speckle reduction, multi-scale or wavelet decomposition with soft thresholding, anisotropic filtering, bilateral filtering, histogram equalization and doppler processing. The one or more images generated are transmitted to the imaging client step 608. The imaging client is configured to render the one or more images through a user interface for a user's view at step 610. Thus the imaging client present in the user device held by the user only needs to present the render the images and all processing of the image data acquired by an image acquisition unit is performed at the imaging server in a remote location.

The various embodiments and/or components, for example, the modules, or components and controllers therein, also may be implemented as part of one or more computers or processors. The computer or processor may include a medical imaging device, a user device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a floppy disk drive, optical disk drive, and the like. The storage device may also be other similar means for loading computer programs or other instructions into the computer or processor. As used herein, the term “computer” or “module” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”. The computer or processor executes a set of instructions that are stored in one or more storage elements, in order to process input data. The storage elements may also store data or other information as desired or needed. The storage element may be in the form of an information source or a physical memory element within a processing machine.

The methods described in conjunction with FIG. 6 can be performed using a processor or any other processing device. The method steps can be implemented using coded instructions (e.g., computer readable instructions) stored on a tangible computer readable medium. The tangible computer readable medium may be for example a flash memory, a read-only memory (ROM), a random access memory (RAM), any other computer readable storage medium and any storage media. Although the method of acquiring an image of an object using a remotely accessible medical imaging device infrastructure is explained with reference to the flow chart of FIG. 6, other methods of implementing the method can be employed. For example, the order of execution of each method steps may be changed, and/or some of the method steps described may be changed, eliminated, divide or combined. Further the method steps of the method shown in FIG. 6 may be sequentially or simultaneously executed.

This written description uses examples to disclose the invention, including the best mode, and also to enable any person skilled in the art to practice the invention, including making and using any computing system or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A medical imaging system, comprising:
an imaging client communicably coupled to an image acquisition unit, wherein the imaging client is configured to:
transmit image data of an object acquired using the image acquisition unit, wherein the image data is acquired based on an imaging procedure; and
at least one imaging server hosting one or more medical imaging device infrastructure and communicably coupled to the imaging client, wherein the at least one imaging server is configured to:
allocate a medical imaging device from the one or more medical imaging device infrastructure to the imaging client based on the imaging procedure,
process the image data received from the imaging client in the medical imaging device to generate at least one image, and
send the at least one image to the imaging client, wherein the imaging client is further configured to render the at least one image of the object.

2. The medical imaging system of claim 1, wherein the imaging client communicates with the at least one imaging server over a wireless network.

3. The medical imaging system of claim 1, wherein the at least one imaging server comprises a virtualization unit configured to:
receive a request for the imaging procedure selected by a user, wherein the request comprises the imaging procedure and at least one imaging parameter associated with the imaging procedure, and
identify the medical imaging device from the one or more medical imaging device infrastructure based on the imaging procedure and the at least one imaging parameter.

4. The medical imaging system of claim 3, wherein the virtualization unit is further configured to determine a load associated with each medical imaging device of the one or more medical imaging device infrastructure, wherein the medical imaging device is allocated to the imaging client based on load associated with the medical imaging device.

5. The medical imaging system of claim 1, wherein the at least one imaging server is further configured to process the image data by:
filtering the image data received from the imaging client to obtain filtered image data,
compressing the filtered image data to generate compressed image data, and
preprocessing the compressed image data to generate the at least one image.

6. The medical imaging system of claim 5, wherein the at least one imaging server is further configured to communicate instructions to the imaging client for operating the image acquisition unit to acquire the image data of the object.

7. The medical imaging system of claim 1, wherein the one or more medical imaging device infrastructure is hosted in a cloud-based environment.

8. The medical imaging system of claim 1, wherein the imaging client comprises a user interface for presenting the at least one image, wherein the user interface is a web-based user interface.

9. The medical imaging system of claim 1, wherein the imaging client is a web-based application.

10. The medical imaging system of claim 1, wherein the imaging client is configured in a user device.

11. A method of acquiring an image of an object using a remotely accessible medical imaging device infrastructure, the method comprising:
transmitting image data of an object acquired using an image acquisition unit to an imaging client, wherein the image data is acquired based on an imaging procedure;
allocating a medical imaging device from one or more medical imaging device infrastructure to the imaging client based on the imaging procedure;
processing the image data received from the imaging client in the medical imaging device to generate at least one image;
sending the at least one image to the imaging client; and
rendering the at least one image of the object by the imaging client.

12. The method of claim 11, wherein allocating the medical imaging device comprises:
receiving a request for the imaging procedure selected by a user, wherein the request comprises the imaging procedure and at least one imaging parameter associated with the imaging procedure; and
identifying the medical imaging device from the one or more medical imaging device infrastructure based on the imaging procedure and the at least one imaging parameter.

13. The method of claim 12, wherein allocating the medical imaging device further comprises:
determining a load associated with each medical imaging device of the one or more medical imaging device infrastructure, wherein the medical imaging device is allocated to the imaging client based on load associated with the medical imaging device.

14. The method of claim 11, wherein processing the image data received from the imaging client comprises:
filtering the image data received from the imaging client to obtain filtered image data;
compressing the filtered image data to generate compressed image data; and
preprocessing the compressed image data to generate the at least one image.

15. The method of claim 11, further comprising:
communicating instructions to the imaging client for operating the image acquisition unit to acquire the image data of the object.
